(19) United States
(12) Patent Application Publication
(10) Pub. No.: US 2021/0181375 A1
(43) Pub. Date: Jun. 17, 2021

(54) NUMERICAL METHOD FOR SIMULATING A KAREZ WELL IN ASSOCIATION WITH A GROUNDWATER MODEL

(71) Applicant: China Institute of Water Resources and Hydropower Research, Beijing (CN)

(72) Inventors: Chuiyu LU, Beijing (CN); Xin HE, Beijing (CN); Qingyan SUN, Beijing (CN); Lingjia YAN, Beijing (CN); Tao QIN, Beijing (CN); Yong ZHAO, Beijing (CN); Tianchen LI, Beijing (CN); Zepeng LI, Beijing (CN); Bo ZHANG, Beijing (CN)

(73) Assignee: China Institute of Water Resources and Hydropower Research, Beijing (CN)

(21) Appl. No.: 16/945,942

(22) Filed: Aug. 3, 2020

(30) Foreign Application Priority Data
Dec. 12, 2019 (CN) 201911270360.2

(51) Int. Cl. G01V 99/00; G06F 30/23; G06F 30/28

(52) U.S. Cl. CPC G01V 99/005; G06F 2111/10; G06F 30/28; G06F 30/23

(57) ABSTRACT

A numerical method for simulating a Karez well in association with a groundwater model includes: first, a Karez well section is divided into an underground channel, an open channel and an overflow area, wherein corresponding parameter values are assigned to each part; second, a Karez well conceptual model is established according to the parameters; third, based on the conceptual model, a dynamic relationship between the Karez well and groundwater is simulated using finite difference matrix equations; fourth, a water balance calculation is performed on the converged simulation result (head values); finally, water balance errors, parameter values in the conceptual model and the simulated head value are computed and output for all time periods. This method can simulate the whole process of the Karez well water flow from water collection to water impounding, providing a new approach for analyzing the Karez well seasonal water demand while used in agricultural water management.

### CROSS REFERENCE TO THE RELATED APPLICATIONS

This application is based upon and claims priority to Chinese Patent Application No. 201911270360.2, filed on Dec. 12, 2019, the entire contents of which are incorporated herein by reference.

### TECHNICAL FIELD

The present invention relates to the technical field of hydrology and water resources, and more particularly, to a numerical method for simulating a Karez well in association with a groundwater model.

### BACKGROUND

A Karez well is mainly composed of vertical shafts, an underground channel, an open channel, and a waterlogging dam (reservoir). Karez wells are generally built along the flow direction of underground subsurface flow, and parallel or oblique to the underground subsurface flow. The vertical shaft has two functions: first, to intercept and collect groundwater; second, to locate the underground channel, access the underground space, discharge soil and provide ventilation during the excavation of the underground channel, so as to facilitate the inspection, annual repair and maintenance in the later-stage operation and management process. The underground channel is generally divided into a water collection section and a water conveyance section. When the surrounding phreatic water level is higher than the underground channel, the underground channel intercepts and collects the groundwater. When the surrounding phreatic water level is lower than the underground channel, the underground channel acts as a water conveyance channel to divert the groundwater collected in the water collection section out of the ground. The open channel is a direct water diversion area that diverts the groundwater from the underground channel into the waterlogging dam. The waterlogging dam is generally built at the end of the open channel and has the main function of impounding water and allocating Karez well water, so that the Karez well water can be fully utilized.

The number of Karez wells has been declining in recent years. In this regard, experts and scholars have carried out extensive research on Karez wells in terms of the use of Karez wells to the social and economic development, residents' lifestyles, and ecological environment value; discussions on the utilization status of the Karez wells, causes of the decline, and protection measures; and innovations in the use of the Karez wells, and others. The current studies are mostly based on field inspections, interviews, historical documents, design index weights and the like, but a systematic analysis method associated with the groundwater level has not been developed in the prior art.

### SUMMARY

The objective of the present invention is to provide a numerical method for simulating a Karez well in association with a groundwater model, which can alleviate the above-mentioned problems.

To alleviate the above-mentioned problems, the present invention adopts the following technical solutions.

The present invention provides a numerical method for simulating a Karez well in association with a groundwater model, including the following steps:

S1, dividing a Karez well section into three parts including an underground channel, an open channel and an overflow area, and assigning corresponding Karez well simulation parameters to each part;

S2, establishing a Karez well conceptual model in a current time period according to the Karez well simulation parameters, wherein the Karez well conceptual model includes an underground channel conceptual model, an open channel conceptual model, and an overflow area conceptual model;

S3, according to the Karez well conceptual model, simulating a dynamic relationship between the Karez well and groundwater by a finite difference matrix equation, and solving the finite difference matrix equation to obtain a simulation result, wherein the simulation result is a head value;

S4, if the simulation result converges, proceeding to step S5, otherwise returning to step S3;

S5, performing a water balance calculation on the converged simulation result by a water balance equation to obtain a water balance error, and then computing and outputting the water balance error, parameter values in the Karez well conceptual model and the simulated head value; and

S6, repeating steps S2-S5 until the water balance errors, the parameter values in the Karez well conceptual model, and the simulated head value are computed and output for all time periods to complete the numerical simulation of the Karez well.

The technical effect achieved by the present technical solution is as follows. The present technical solution provides a systematic analysis method associated with the groundwater level, which can realize the systematic simulation of the whole process of the water flow in the Karez well from water collection to water impounding, provides a new approach for analyzing the Karez well seasonal water demand while used in agricultural water management, and establishes a model for analyzing the relationship between agricultural water consumption and ecological water consumption of the Karez well.

Further, in step S1, the Karez well simulation parameters include Karez well basic data, evaporation data and artificial water withdrawal data. The Karez well basic data includes a Karez well number, Karez well attribute data, an inflow and an outflow. The Karez well attribute data includes a length and a width of the Karez well, a ground slope, a bottom elevation and a bottom thickness of the Karez well, and a Manning roughness coefficient. The evaporation data includes an evaporation intensity. The artificial water withdrawal data includes a water withdrawal manner and a water withdrawal amount.

The technical effect achieved by the present technical solution is as follows. The Karez well, as the study subject, can be generalized to a Karez well simulation structure by these parameters, thus providing an approach to linking the hydraulic connections between different parts of the Karez well.

Further, in step S2, the underground channel conceptual model is constructed via a water seepage flow Q₁ by dividing the underground channel into a plurality of sections in sequence along the length direction of the underground channel to construct a functional model of an amount of water exchange between each underground channel section and an underground aquifer, wherein the functional model of the amount of water exchange between the underground channel section and the underground aquifer is expressed by formula (1):

Q_{con1}=Q₁ (1)

where, Q_{con1} denotes the amount of water exchange between the underground channel section of the Karez well and the underground aquifer;

the open channel conceptual model is constructed via a water seepage flow Q₂, a water evaporation amount Qₑₜₐ₂ and a water consumption Qᵤ by dividing the open channel into a plurality of sections in sequence along the length direction of the open channel to construct a functional model of an amount of water exchange between each open channel section and the underground aquifer, wherein the functional model of the amount of water exchange between the open channel section and the underground aquifer is expressed by formula (2):

Q_{con2}=Q₂+Qₑₜₐ₂+Qᵤ (2)

where, Q_{con2} denotes the amount of water exchange between the open channel section of the Karez well and the underground aquifer; and

the overflow area conceptual model is constructed via a water seepage flow Q₃ and a water evaporation amount Qₑₜₐ₃ by dividing the overflow area into a plurality of sections in sequence along the length direction of the overflow area to construct a functional model of an amount of water exchange between each overflow area section and the underground aquifer, wherein the functional model of the amount of water exchange between the overflow area section and the underground aquifer is expressed by formula (3):

Q_{con3}=Q₃+Qₑₜₐ₃ (3)

where, Q_{con3} denotes the amount of water exchange between the overflow area section of the Karez well and the underground aquifer.

The technical effect achieved by the present technical solution is as follows. The connection between different Karez well conceptual models is established by the Karez well simulation structure. Based on the analysis of the whole process of the Karez well, the amounts of water exchange between the different Karez well conceptual models and the underground aquifer are calculated by the corresponding formulas, thus achieving the modeling of the Karez well.

Further, the water seepage flow Q₁ of the underground channel section, the water seepage flow Q₂ of the open channel section and the water seepage flow Q₃ of the overflow area section are calculated in the same manner by the following steps:

a1, calculating a water level Hs of a target water flow area according to the Manning formula expressed by formula (4):

$$Hs = {[ \frac{Qn}{{CWS}^{\frac{1}{2}}} ]}^{\frac{3}{5}} \qquad ( 4 )$$

where, Q denotes an inflow of the target water flow area; n denotes a Manning roughness coefficient of the target water flow area; C denotes a hydraulic conductivity between the target water flow area and the underground aquifer; W denotes a width of the target water flow area; and S denotes a slope of the target water flow area;

a2, calculating a water seepage flow Qₛ of the target water flow area by Darcy's law expressed by the following formulas, if Ha≤HBOT, then calculating Qₛ by formula (5); if Ha>HBOT, then calculating Qₛ by formula (6),

Qₛ=CSTR(Hs−HBOT) (5)

Qₛ=CSTR(Hs−Ha) (6)

where, CSTR denotes a hydraulic conductivity of an interconnection between the target water flow area and the underground aquifer; Ha denotes a water level of the underground aquifer in the target water flow area; and HBOT denotes a base elevation of the target water flow area.

The technical effect achieved by the present technical solution is as follows. The modeling of the seepage and discharge processes in different parts of the Karez well is realized.

Further, if the target water flow area is an underground channel section, the base elevation of the target water flow area is obtained by performing an inverse calculation on an elevation of a water outlet of the Karez well and a length of the underground channel section.

Further, the water evaporation amount Qₑₜₐ₂ of the open channel section and the water evaporation amount Qₑₜₐ₃ of the overflow area section are calculated in the same manner by the following steps:

b1, calculating an evaporation loss in the target water flow area by formula (7),

ETₚ=αW₂d (7)

where, ETₚ denotes potential evaporation of the target water flow area, a denotes an evaporation intensity of the target water flow area, and d denotes a length of the target water flow area; and

b2, comparing the inflow Q of the target water flow area with the potential evaporation ETₚ of the target water flow area, and selecting a relatively small value as the water evaporation amount Qₑₜₐ of the target water flow area.

The technical effect achieved by the present technical solution is as follows. The modeling of the evaporation process of the Karez well is realized.

Further, the water consumption Qᵤ₂ of the open channel section is obtained by adding a centralized water consumption and a phasing irrigation water consumption.

The technical effect achieved by the present technical solution is as follows. The modeling of the water use process of the Karez well is realized.

Further, step S3 specifically includes the following steps:

S31, using the underground channel section, the open channel section and the overflow area section as calculation units, and constructing a finite difference equation for the calculation units as follows:

$$C {V}_{i , j , k - \frac{1}{2}} {h}_{i , j , k - 1}^{m} + C {C}_{i - \frac{1}{2} , j , k ,} {h}_{i - 1 , j , k}^{m} + {CR}_{i , j - \frac{1}{2} , k} {h}_{i , j - 1 , k}^{m} + ( - {CV}_{i , j , k - \frac{1}{2}} - {CC}_{i - \frac{1}{2} , j , k ,} - {CR}_{i , j - \frac{1}{2} , k} - {CR}_{i , j + \frac{1}{2} , k} - {CC}_{i + \frac{1}{2} , j , k ,} - {CV}_{i , j , k + \frac{1}{2}} + {HCOF}_{i , j , k} ) {h}_{i , j , k}^{m} + {CR}_{i , j + \frac{1}{2} , k} {h}_{i , j + 1 , k}^{m} + {CC}_{i + \frac{1}{2} , j , k ,} {h}_{i + 1 , j , k}^{m} + {CV}_{i , j , k + \frac{1}{2}} {h}_{i , j , k + 1}^{m} = {RHS}_{i , j , k}$$

where, CV, CC, and CR denote a vertical hydraulic conductivity, a horizontal hydraulic conductivity and a longitudinal hydraulic conductivity of the calculation units inflowing into the groundwater, respectively; i, j, and k denote a row number, a column number, and a layer number of the calculation unit, respectively; m denotes a time period number; h denotes a head; and HCOF and RHS both denote a differential term; and

S32, adding Q₁, Q₂ and Q₃ in the Karez well conceptual model to the HCOF differential term, adding Qₑₜₐ₂, Qₑₜₐ₃ and Qᵤ in the Karez well conceptual model to the RHS differential term, constructing a system of linear equations expressed as [A]{h}={q} using the finite difference equation of each calculation unit, where, [A] denotes a coefficient matrix of the head, {h} denotes a head matrix to be solved, and {q} denotes all the constant terms and known terms contained in each equation; and solving {h} by an iterative method to obtain the simulation result.

Further, in step S5, the water balance equation is expressed as follows:

BALERRₖ=(Qᵢₙₖ−Qₒᵤₜₖ)−(Qₖ+Qₑₜₐₖ+Qᵤₖ), k=1, 2 . . . n₁;

where, k denotes the numbering of the Karez well section, n₁ denotes the quantity of the Karez well sections, BALERRₖ denotes a water balance error of a k^{th} Karez well section to be solved, Qᵢₙₖ denotes an actual inflow at the head end of the k^{th} Karez well section, Qₒᵤₜₖ denotes an actual outflow of the k^{th} Karez well section, and Qₖ denotes a seepage flow of the k^{th} Karez well section; Qₑₜₐₖ denotes an evaporation amount of the k^{th} Karez well section, and when the k^{th} Karez well section belongs to the underground channel, the value of Qₑₜₐₖ is 0; Qᵤₖ denotes the water consumption of the k^{th} Karez well section, and when the k^{th} Karez well section belongs to the underground channel or the overflow area, the value of Qᵤₖ is 0.

In order to make the above-mentioned objectives, features and advantages of the present invention more obvious and understandable, hereinafter, the embodiments of the present invention are specifically exemplified and described in detail with reference to the drawings.

### BRIEF DESCRIPTION OF THE DRAWINGS

In order to more clearly explain the technical solutions of the embodiments of the present invention, the drawings used in the embodiments will be briefly described hereinafter. It should be understood that the drawings only show some embodiments of the present invention, and thus should not be construed as a limitation on the scope. Those having ordinary skill in the art can also obtain other related drawings according to these drawings without creative efforts.

FIG. 1 is a flow chart of the numerical method for simulating the Karez well according to an embodiment; and

FIG. 2 is a cross-sectional view of the Karez well according to an embodiment.

In the figures: 1—underground channel, 2—open channel, 3—overflow area, 4—underground aquifer.

### DETAILED DESCRIPTION OF THE EMBODIMENTS

In order to make the objectives, technical solutions and advantages of the embodiments of the present invention clearer, the technical solutions in the embodiments of the present invention will be expressly and completely described hereinafter with reference to the drawings used in the embodiments of the present invention. Obviously, the described embodiments are a part of the embodiments of the present invention rather than all the embodiments. The components of the embodiments of the present invention described and illustrated in the drawings herein can generally be arranged and designed in different configurations.

Therefore, the following detailed description of the embodiments of the present invention provided in the drawings is not intended to limit the scope of the present invention, but only represent the preferred embodiments of the present invention. All other embodiments obtained by those having ordinary skill in the art based on the embodiments in the present invention without creative efforts shall fall within the scope of the present invention.

### Embodiments

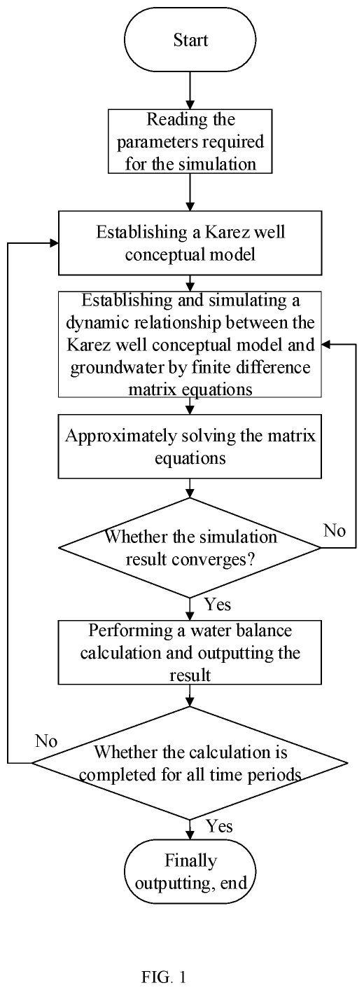

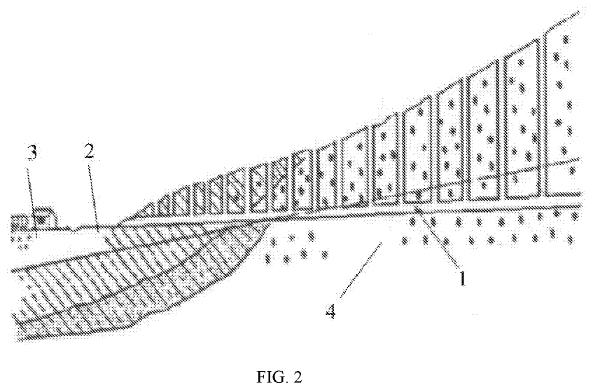

Referring to FIGS. 1-2, the present embodiment provides a numerical method for simulating a Karez well in association with a groundwater model, including the following steps.

S1: A Karez well section is divided into three parts including an underground channel, an open channel and an overflow area, and the corresponding Karez well simulation parameters are assigned to each part.

S2: A Karez well conceptual model in a current time period is established according to the Karez well simulation parameters, wherein the Karez well conceptual model includes an underground channel conceptual model, an open channel conceptual model, and an overflow area conceptual model.

S3: According to the Karez well conceptual model, a dynamic relationship between the Karez well and groundwater is simulated by a finite difference matrix equation, and the finite difference matrix equation is solved to obtain a simulation result, wherein the simulation result is a head value.

S4: If the simulation result converges, then proceeding to step S5, otherwise returning to step S3.

S5: A water balance calculation is performed on the converged simulation result by a water balance equation to obtain a water balance error, and then the water balance error, parameter values in the Karez well conceptual model and the simulated head value are computed and output.

S6: Steps S2-S5 are repeated until the water balance errors, the parameter values in the Karez well conceptual model and the simulated head value are computed and output for all time periods to complete the numerical simulation of the Karez well.

In the present embodiment, the Karez well simulation parameters include Karez well basic data, evaporation data and artificial water withdrawal data. The Karez well basic data includes a Karez well number, Karez well attribute data, an inflow (an amount of water flowing into the present Karez well part) and an outflow (an amount of water flowing out from the present Karez well part). The Karez well attribute data includes the length and width of the Karez well, the ground slope, the bottom elevation and bottom thickness of the Karez well, and the Manning roughness coefficient. The evaporation data includes the evaporation intensity. The artificial water withdrawal data includes a water withdrawal manner (including the manner of using water along the way and the manner of using water at the end) and a water withdrawal amount (an amount of water artificially removed for use).

In the present embodiment, the whole simulation process is divided into a series of time periods. The length of each time period is calculated based on a total duration, an accelerating factor, and other parameters, which is used herein as a unit only for measuring time. The simulation is to obtain a head value at the end of each time period by a finite difference equation.

In the present embodiment, according to the read basic parameters, the Karez well is generalized into a seasonal river to simulate the water flow process. The Karez well is divided into three parts to establish the model. The first part is the underground channel for simulating the recharge and discharge relationship between the Karez well water flow and the groundwater. The second part is the open channel for simulating a water loss and artificial withdrawal process of the Karez well flow in the open channel. The third part is an overflow area for simulating the infiltration and recharge process of the remaining irrigation water into the ecosystem during the non-irrigation period. The seepage, recharge, evaporation and water consumption of the three parts are shown in Table 1.

TABLE 1
Recharge and discharge manner of the three parts of the Karez well

| | | | | | Water |
|---|---|---|---|---|---|
| | | Seepage | Recharge | Evaporation | use |
| | Name | process | process | process | process |
| First part | Underground | √ | √ | x | x |
| | channel | | | | |
| Second part | Open channel | √ | x | √ | √ |
| Third part | Overflow | √ | x | √ | x |
| | area | | | | |

In the present embodiment, the water seepage flow indicates the seepage process and the recharge process.

The underground channel of the Karez well is an underground river that runs beneath the ground surface, and thus only has the recharge process and seepage process. As shown in FIG. 2, according to the difference in height between the groundwater level and the bottom of the underground channel, the underground channel section is divided into a water collection section and a water conveyance section. In the water collection section, the groundwater level is higher than the bottom of the underground channel, and the water in the aquifer flows toward the underground channel and is collected to recharge the underground channel. In the water conveyance section, the groundwater level is lower than the bottom of the underground channel, and the water flow leaks in the course of flowing along the channel.

The underground channel conceptual model is constructed via the water seepage flow Q₁ by dividing the underground channel into a plurality of sections in sequence along the length direction of the underground channel to construct a functional model of an amount of water exchange between each underground channel section and the underground aquifer, wherein the functional model of the amount of water exchange between the underground channel section and the underground aquifer is expressed by formula (1),

Q_{con1}=Q₁ (1)

where, Q_{con1} denotes the amount of water exchange between the underground channel section of the Karez well and the underground aquifer;

There is a seepage process from the open channel to the underground aquifer. This part of the seepage flow is not large, but can still create an oasis to improve the ecological environment system. The open channel conceptual model is constructed via the water seepage flow Q₂, the water evaporation amount Qₑₜₐ₂ and the water consumption Qᵤ by dividing the open channel into a plurality of sections in sequence along the length direction of the open channel to construct a functional model of an amount of water exchange between each open channel section and the underground aquifer, wherein the functional model of the amount of water exchange between the open channel section and the underground aquifer expressed by formula (2),

Q_{con2}=Q₂+Qₑₜₐ₂+Qᵤ (2)

where, Q_{con2} denotes the amount of water exchange between the open channel section of the Karez well and the underground aquifer.

During the non-irrigation period, a part of the Karez well water leaves the open channel and flows downstream along the ground. The water flowing into the overflow area is the remaining irrigation water that recharges the ecosystem to form the infiltration process. The overflow area conceptual model is constructed via the water seepage flow Q₃ and the water evaporation amount Qₑₜₐ₃ by dividing the overflow area into a plurality of sections in sequence along the length direction of the overflow area to construct a functional model of an amount of water exchange between each overflow area section and the underground aquifer, wherein the functional model of the amount of water exchange between the overflow area section and the underground aquifer is expressed by formula (3),

Q_{con3}=Q₃+Qₑₜₐ₃ (3)

where, Q_{con3} denotes the amount of water exchange between the overflow area section of the Karez well and the underground aquifer.

In the present embodiment, the water seepage flow Q₁ of the underground channel section, the water seepage flow Q₂ of the open channel section and the water seepage flow Q₃ of the overflow area section are calculated in the same manner by the following steps:

a1: The water level Hs of the target water flow area is calculated according to the Manning formula expressed by formula (4),

$$Hs = {[ \frac{Qn}{{CWS}^{\frac{1}{2}}} ]}^{\frac{3}{5}} \qquad ( 4 )$$

where, Q denotes an inflow of the target water flow area; n denotes a Manning roughness coefficient of the target water flow area; C denotes a hydraulic conductivity between the target water flow area and the underground aquifer; W denotes a width of the target water flow area; and S denotes a slope of the target water flow area;

a2: The water seepage flow Qₛ of the target water flow area is calculated by Darcy's law expressed by the following formulas. If Ha≤HBOT, then Qₛ is calculated by formula (5). If Ha>HBOT, then Qₛ is calculated by formula (6),

Qₛ=CSTR(Hs−HBOT) (5)

Qₛ=CSTR(Hs−Ha) (6)

where, CSTR denotes a hydraulic conductivity of the interconnection between the target water flow area and the underground aquifer; Ha denotes a water level of the underground aquifer in the target water flow area; and HBOT denotes a base elevation of the target water flow area.

In the present embodiment, the target water flow area is an underground channel section, an open channel section or an overflow area section. If the target water flow area is an underground channel section, the base elevation of the target water flow area is obtained by performing an inverse calculation on the elevation of the water outlet of the Karez well and the length of the underground channel section.

In the present embodiment, the water evaporation amount Qₑₜₐ₂ of the open channel section and the water evaporation amount Qₑₜₐ₃ of the overflow area section are calculated in the same manner by the following steps:

b1: The evaporation loss in the target water flow area is calculated by formula (7),

ETₚ=αW₂d (7)

where, ETₚ denotes potential evaporation of the target water flow area, a denotes an evaporation intensity of the target water flow area, and d denotes a length of the target water flow area.

b2: The inflow Q of the target water flow area is compared with the potential evaporation ETₚ of the target water flow area, and a relatively small value is selected as the water evaporation amount Qₑₜₐ of the target water flow area.

In the present embodiment, the water consumption Qᵤ₂ of the open channel section is obtained by adding the centralized water consumption and the phasing irrigation water consumption.

In the present embodiment, step S3 specifically includes the following steps:

S31: The underground channel section, the open channel section and the overflow area section are used as calculation units, and a finite difference equation for the calculation units is constructed as follows:

$$C {V}_{i , j , k - \frac{1}{2}} {h}_{i , j , k - 1}^{m} + C {C}_{i - \frac{1}{2} , j , k ,} {h}_{i - 1 , j , k}^{m} + {CR}_{i , j - \frac{1}{2} , k} {h}_{i , j - 1 , k}^{m} + ( - {CV}_{i , j , k - \frac{1}{2}} - {CC}_{i - \frac{1}{2} , j , k ,} - {CR}_{i , j - \frac{1}{2} , k} - {CR}_{i , j + \frac{1}{2} , k} - {CC}_{i + \frac{1}{2} , j , k ,} - {CV}_{i , j , k + \frac{1}{2}} + {HCOF}_{i , j , k} ) {h}_{i , j , k}^{m} + {CR}_{i , j + \frac{1}{2} , k} {h}_{i , j + 1 , k}^{m} + {CC}_{i + \frac{1}{2} , j , k ,} {h}_{i + 1 , j , k}^{m} + {CV}_{i , j , k + \frac{1}{2}} {h}_{i , j , k + 1}^{m} = {RHS}_{i , j , k}$$

where, CV, CC, and CR denote a vertical hydraulic conductivity, a horizontal hydraulic conductivity and a longitudinal hydraulic conductivity of the calculation units inflowing into the groundwater, respectively; i, j, and k denote a row number, a column number and a layer number of the calculation unit, respectively; m denotes a time period number; h denotes a head; and HCOF and RHS both denote a differential term.

S32: Q₁, Q₂ and Q₃ in the Karez well conceptual model are added to the HCOF differential term, Qₑₜₐ₂, Qₑₜₐ₃ and Qᵤ in the Karez well conceptual model are added to the RHS differential term, a system of linear equations is constructed using the finite difference equation of each calculation unit and expressed as [A]{h}={q}, where [A] denotes a coefficient matrix of the head, {h} denotes a head matrix to be solved, {q} denotes all the constant and known terms contained in each equation, and {h} is solved by an iterative method to obtain the simulation result.

In the iterative calculation process of the present embodiment, the results of each iteration are processed for the next calculation. Different algorithms have different processing methods. Under normal circumstances, the head change after each iteration gradually decreases and eventually reaches convergence to complete the head calculation in one time period. The head value is determined whether to converge or not by a predefined convergence index. When the maximum head difference calculated in two iterations is less than the convergence index, the head value converges. Starting from the initial head, a head value is determined in each iteration at the end of each time period and used as the initial value of the next time period, and this process is repeated until the required time ends. If the head of the water conveyance channel does not reach the convergence value, the water demand calculation is restarted until the iteration converges.

S5: After the result of the water level converges, according to the head value h and the flow rate between the calculation units, the specific values of all parameters in the seepage process, evaporation process, and water use process of the Karez well in the current time period can be calculated and obtained.

In step S5 of the present embodiment, the water balance equation is expressed as follows:

BALERRₖ=Qᵢₙₖ−Qₒᵤₜₖ)−Qₖ+Qₑₜₐₖ+Qᵤₖ), k=1,2 . . . n₁;

where, k denotes the numbering of the Karez well section, n₁ denotes the quantity of the Karez well sections, BALERRₖ denotes a water balance error of the k^{th} Karez well section to be solved, Qᵢₙₖ denotes an actual inflow at the head end of the k^{th} Karez well section, Qₒᵤₜₖ denotes an actual outflow of the k^{th} Karez well section, and Qₖ denotes a seepage flow of the k^{th} Karez well section; Qₑₜₐₖ denotes an evaporation amount of the k^{th} Karez well section, and when the k^{th} Karez well section belongs to the underground channel, the value of Qₑₜₐₖ is 0; and Qᵤₖ denotes water consumption of the k^{th} Karez well section, and when the k^{th} Karez well section belongs to the underground channel or the overflow area, the value of Qᵤₖ is 0.

The above-mentioned descriptions are only the preferred embodiments of the present invention and are not intended to limit the present invention. Those skilled in the art can make various modifications and changes to the present invention. Any modifications, equivalent replacements, improvements and the like made within the spirit and principle of the present invention shall fall within the scope of protection of the present invention.

What is claimed is:

1. A numerical method for simulating a Karez well in association with a groundwater model, comprising the following steps:
S1, dividing a Karez well section of the Karez well into three parts, wherein the three parts comprise an underground channel, an open channel, and an overflow area; and assigning Karez well simulation parameters to each part of the three parts;
S2, establishing a Karez well conceptual model in a current time period according to the Karez well simulation parameters, wherein the Karez well conceptual model comprises an underground channel conceptual model, an open channel conceptual model, and an overflow area conceptual model;
S3, according to the Karez well conceptual model, simulating a dynamic relationship between the Karez well and groundwater by a finite difference matrix equation, and solving the finite difference matrix equation to obtain a simulation result, wherein the simulation result is a head value;
S4, if the simulation result converges to a converged simulation result, proceeding to step S5; if the simulation result does not converge, returning to step S3;
S5, performing a water balance calculation on the converged simulation result by a water balance equation to obtain a water balance error, and computing and outputting the water balance error, parameter values of the Karez well simulation parameters in the Karez well conceptual model and a simulated head value; and
S6, repeating steps S2-S5 until the water balance error in each time period, the parameter values of the Karez well simulation parameters in the Karez well conceptual model and the simulated head value are computed and output to complete a numerical simulation of the Karez well.

2. The numerical method for simulating the Karez well in association with the groundwater model according to claim 1, wherein, in step S1, the Karez well simulation parameters comprise Karez well basic data, evaporation data and artificial water withdrawal data; the Karez well basic data comprises a Karez well number, Karez well attribute data, an inflow and an outflow; the Karez well attribute data comprises a length and a width of the Karez well, a ground slope, a bottom elevation and a bottom thickness of the Karez well, and a Manning roughness coefficient; the evaporation data comprises an evaporation intensity; the artificial water withdrawal data comprises a water withdrawal manner and a water withdrawal amount.

3. The numerical method for simulating the Karez well in association with the groundwater model according to claim 2, wherein, in step S2,
the underground channel conceptual model is constructed via a water seepage flow Q₁ by dividing the underground channel into a plurality of underground channel sections in sequence along a length direction of the underground channel to construct a functional model of an amount of a water exchange between each underground channel section of the plurality of underground channel sections and an underground aquifer, wherein the functional model of the amount of the water exchange between the each underground channel section and the underground aquifer is expressed by formula (1):
Q_{con1}=Q₁ (1)
where, Q_{con1} denotes the amount of the water exchange between the each underground channel section of the Karez well and the underground aquifer;
the open channel conceptual model is constructed via a water seepage flow Q₂, a water evaporation amount Qₑₜₐ₂ and a water consumption Qᵤ by dividing the open channel into a plurality of open channel sections in sequence long a length direction of the open channel to construct a functional model of an amount of a water exchange between each open channel section of the plurality of open channel sections and the underground aquifer, wherein the functional model of the amount of the water exchange between the each open channel section and the underground aquifer is expressed by formula (2):
Q_{con2}=Q₂+Qₑₜₐ₂+Qᵤ, (2)
where, Q_{con2} denotes the amount of the water exchange between the each open channel section of the Karez well and the underground aquifer; and
the overflow area conceptual model is constructed via a water seepage flow Q₃ and a water evaporation amount Qₑₜₐ₃ by dividing the overflow area into a plurality of overflow area sections in sequence along a length direction of the overflow area to construct a functional model of an amount of a water exchange between each overflow area section of the plurality of overflow area sections and the underground aquifer, wherein the functional model of the amount of the water exchange between the each overflow area section and the underground aquifer is expressed by formula (3):
Q_{con3}=Q₃+Qₑₜₐ₃ (3)
where, Q_{con3} denotes the amount of the water exchange between the each overflow area section of the Karez well and the underground aquifer.

4. The numerical method for simulating the Karez well in association with the groundwater model according to claim 3, wherein, the water seepage flow Q₁ of the each underground channel section, the water seepage flow Q₂ of the each open channel section and the water seepage flow Q₃ of the each overflow area section are calculated by the following steps:
a1, calculating a water level Hs of a target water flow area according to a Manning formula expressed by formula (4):
$$Hs = {[ \frac{Qn}{{CWS}^{\frac{1}{2}}} ]}^{\frac{3}{5}} \qquad ( 4 )$$
where, Q denotes the inflow of the target water flow area; n denotes the Manning roughness coefficient of the target water flow area; C denotes a hydraulic conductivity between the target water flow area and the underground aquifer; W denotes a width of the target water flow area; and S denotes a slope of the target water flow area;
a2, calculating a water seepage flow Qₛ of the target water flow area by Darcy's law expressed by the following formulas, if Ha≤HBOT, calculating Qₛ by formula (5); if Ha>HBOT, calculating Qₛ by formula (6),
Qₛ=CSTR(Hs−HBOT) (5)
Qₛ=CSTR(Hs−Ha) (6)
where, CSTR denotes a hydraulic conductivity of an interconnection between the target water flow area and the underground aquifer; Ha denotes a water level of the underground aquifer in the target water flow area; and HBOT denotes a base elevation of the target water flow area.

5. The numerical method for simulating the Karez well in association with the groundwater model according to claim 4, wherein, if the target water flow area is an underground channel section of the plurality of underground channel sections, the base elevation of the target water flow area is obtained by performing an inverse calculation on an elevation of a water outlet of the Karez well and a length of the underground channel section.

6. The numerical method for simulating the Karez well in association with the groundwater model according to claim 4, wherein, the water evaporation amount Qₑₜₐ₂ of the each open channel section and the water evaporation amount Qₑₜₐ₃ of the each overflow area section are calculated by the following steps:
b1, calculating an evaporation loss in the target water flow area by formula (7),
ETₚ=αW₂d (7)
where, ETₚ denotes a potential evaporation of the target water flow area, a denotes an evaporation intensity of the target water flow area, and d denotes a length of the target water flow area; and
b2, comparing the inflow Q of the target water flow area with the potential evaporation ETₚ of the target water flow area, and selecting a relatively small value of the inflow Q and the potential evaporation ETₚ as a water evaporation amount Qₑₜₐ of the target water flow area.

7. The numerical method for simulating the Karez well in association with the groundwater model according to claim 4, wherein, the water consumption Qᵤ of the each open channel section is obtained by adding a centralized water consumption and a phasing irrigation water consumption.

8. The numerical method for simulating the Karez well in association with the groundwater model according to claim 3, wherein, step S3 specifically comprises the following steps:
S31, using the each underground channel section, the each open channel section and the each overflow area section as calculation units, and constructing a finite difference equation for the calculation units as follows:
$$C {V}_{i , j , k - \frac{1}{2}} {h}_{i , j , k - 1}^{m} + C {C}_{i - \frac{1}{2} , j , k ,} {h}_{i - 1 , j , k}^{m} + {CR}_{i , j - \frac{1}{2} , k} {h}_{i , j - 1 , k}^{m} + ( - {CV}_{i , j , k - \frac{1}{2}} - {CC}_{i - \frac{1}{2} , j , k ,} - {CR}_{i , j - \frac{1}{2} , k} - {CR}_{i , j + \frac{1}{2} , k} - {CC}_{i + \frac{1}{2} , j , k ,} - {CV}_{i , j , k + \frac{1}{2}} + {HCOF}_{i , j , k} ) {h}_{i , j , k}^{m} + {CR}_{i , j + \frac{1}{2} , k} {h}_{i , j + 1 , k}^{m} + {CC}_{i + \frac{1}{2} , j , k ,} {h}_{i + 1 , j , k}^{m} + {CV}_{i , j , k + \frac{1}{2}} {h}_{i , j , k + 1}^{m} = {RHS}_{i , j , k}$$
where, CV, CC, and CR denote a vertical hydraulic conductivity, a horizontal hydraulic conductivity and a longitudinal hydraulic conductivity of each calculation unit of the calculation units, respectively, wherein the each calculation unit inflows into the groundwater; i, j, and k denote a row number, a column number, and a layer number of the each calculation unit, respectively; m denotes a time period number; h denotes a head; and HCOF and RHS denote a first differential term and a second differential term, respectively; and
S32, adding Q₁, Q₂ and Q₃ in the Karez well conceptual model to the first differential term, adding Qₑₜₐ₂, Qₑₜₐ₃ and Qᵤ in the Karez well conceptual model to the second differential term, constructing a system of linear equations expressed as [A]{h}={q} using the finite difference equation of the each calculation unit, where, [A] denotes a coefficient matrix of the head, {h} denotes a head matrix to be solved, and {q} denotes constant terms and known terms contained in each equation in the system of the linear equations; and solving {h} by an iterative method to obtain the simulation result.

9. The numerical method for simulating the Karez well in association with the groundwater model according to claim 3, wherein, in step S5, the water balance equation is expressed as follows:
BALERRₖ=(Qᵢₙₖ−Qₒᵤₜₖ)−(Qₖ+Qₑₜₐₖ+Qᵤₖ), k=1,2 . . . n₁;
where, k denotes a numbering of the Karez well section, n₁ denotes a quantity of the Karez well section, BALERRₖ denotes a water balance error of a k^{th} Karez well section to be solved, Qᵢₙₖ denotes an actual inflow at a head end of the k^{th} Karez well section, Qₒᵤₜₖ denotes an actual outflow of the k^{th} Karez well section, Qₖ denotes a seepage flow of the k^{th} Karez well section, Qₑₜₐₖ denotes an evaporation amount of the k^{th} Karez well section, and Qᵤₖ denotes a water consumption of the k^{th} Karez well section; when the k^{th} Karez well section belongs to the underground channel, a value of Qₑₜₐk is 0; and when the k^{th} Karez well section belongs to the underground channel or the overflow area, a value of Qᵤₖ is 0.
